(19) United States
(12) Patent Application Publication
(10) Pub. No.: US 2026/0067605 A1
(43) Pub. Date: Mar. 5, 2026

(54) SPEAKER MODULE

(71) Applicant: Marshall Group AB, Stockholm (SE)

(72) Inventor: Daniel Andersson, Gustavsberg (SE)

(21) Appl. No.: 19/105,504

(22) PCT Filed: Aug. 24, 2023
(86) PCT No.: PCT/EP2023/073298

§ 371 Date: Feb. 21, 2025

(30) Foreign Application Priority Data
Sep. 5, 2022 (SE) 2251027-5

(51) Int. Cl. H04R 1/10

(52) U.S. Cl. CPC H04R 1/1016; H04R 1/1041; H04R 1/1075; H04R 1/1083; H04R 2410/05; H04R 2420/07; H04R 2460/01

(57) ABSTRACT

A speaker module (100), is presented. The speaker module (100) comprises a speaker element (110), an interface (120) for receiving audio, a configurable driver circuit (130) configured to drive the speaker element (110) based on audio provided from the interface (120), and a configuration circuit (140) operatively connected to the configurable driver circuit (130). The configurable driver circuit (130) is configured to operate at a first configuration responsive to the configuration circuit (140) indicating a first state of the speaker module (100) and at a second configuration responsive to the configuration circuit (140) detecting a second state of the speaker module (100). The first state is an earbud state, and the second state is an in-ear state.

### TECHNICAL FIELD

The present disclosure relates to a speaker module, and more precisely to a speaker module being reconfigurable between a first state and a second state.

### BACKGROUND

With the advent of mobile electronics and streamed media, access to music, video and interactions with other people has become a breeze. From e.g. a mobile phone, it is possible to listen to your favorite music, talk to relatives, enjoy a podcast or an audiobook wherever you are. In order not to disturb other people, or have others eavesdrop on private conversations, it is commonplace to enjoy the streamed media through a listening device such as a pair of headphone or earphones.

Headphones are available in many different sizes and shapes, and there is not one design that is a perfect fit for all people and all use-cases. The headphones that are most practical and comfortable when working out may be quite different from the ones that are most comfortable when listening to an audiobook on the couch.

A common solution is to have a number of different headphones and use different headphones depending on situation. This is not only costly for the user as several headphones has to be acquired, it is also inconvenient to have to store, bring and keep track of a number of different headphones. In addition to this, the more headphones, the greater the negative environmental impact. To exemplify, headphones are commonly wireless devices which implies that they comprise a battery or other energy source, these energy sources are not environmentally sound. Any battery, semiconductor or other component of the headphones is likely to comprise rare materials (metals) or other components that have a negative impact on the environment when obtained, discarded or even when recycled. As is known, production of any device (be it headphones or cars) generally comes with a significant carbon footprint.

### SUMMARY

It is in view of the above considerations and others, that the various embodiments of this disclosure have been made. The present disclosure therefore recognizes the fact that there is a need for alternatives to (e.g. improvement of) the existing art described above.

It is an object of some embodiments to solve, mitigate, alleviate, or eliminate at least some of the above or other disadvantages.

An object of the present disclosure is to provide a new type of speaker module which is improved over prior art and which eliminates or at least mitigates one or more of the drawbacks discussed above. More specifically, an object of the invention is to provide a speaker module that is reconfigurable and which may be used in more than one configuration. These objects are achieved by the technique set forth in the appended independent claims with preferred embodiments defined in the dependent claims related thereto.

In a first aspect, a speaker module is presented. The speaker module comprises a speaker element, an interface for receiving audio, a configurable driver circuit configured to drive the speaker element based on audio provided from the interface, and a configuration circuit operatively connected to the configurable driver circuit. The configurable driver circuit is configured to operate at a first configuration responsive to the configuration circuit indicating a first state of the speaker module and at a second configuration responsive to the configuration circuit detecting a second state of the speaker module. The first state is an earbud state, and the second state is an in-ear state.

In one variant, the configuration circuit comprises a sensor circuit configured to sense, or otherwise detect, the state of the speaker module. This is beneficial as automation of the state detection is simplified.

For example, the configuration circuit may be configured to determine the state of the speaker module by one or more of electro-mechanical detection, electro-acoustic detection or proximity sensing. In one variant, the sensor circuit may therefore comprise one or more of an electro-mechanical element, an electro-acoustic element or a proximity sensing element configured to detect the state of the speaker module. This is beneficial as automation of the state detection is simplified.

In one variant, the configuration circuit comprises a user-operable switch element operable in at least one of a first setting and a second setting, wherein the configuration circuit is configured to indicate the first state responsive to the user-operable switch element being set to the first setting and to indicate the second state responsive to the user-operable switch element being set to the second setting. This is beneficial as the state detection may be controlled by the user e.g. at the speaker module if it is a physical switch element, or remotely through e.g. a mobile phone if it is a switch element provided in software.

In one variant, the interface is configured for communication across a wireless interface, advantageously the wireless interface is a Bluetooth interface.

In one variant, the speaker module is further configured to communicate with a remote speaker module across the wireless interface. This is beneficial as it enables the speaker module to form part of a true wireless stereo system.

In one variant, the speaker module further comprises one or more microphones. The speaker module is configured to provide active noise cancellation (ANC) by the configurable driver circuit further being configured to drive the speaker element based on audio obtained from the one or more microphones.

In one variant, the speaker module further comprises a housing arranged to at least partly encompass the speaker element.

In one variant, the housing of the speaker module is formed as an earbud. This is beneficial as no additional elements are required when operating the speaker module at the earbud state.

In a second aspect, a reconfigurable earbud earphone is presented. The reconfigurable earbud earphone comprises a speaker module and a removable earbud attachment element. The speaker module comprises a speaker element, an interface for receiving audio, a configurable driver circuit configured to drive the speaker element based on audio provided from the interface, and a configuration circuit operatively connected to the configurable driver circuit. The configurable driver circuit is configured to operate at a first configuration responsive to the configuration circuit indicating a first state of the speaker module and at a second configuration responsive to the configuration circuit indicating a second state of the speaker module, wherein the first state is an earbud state, and the second state is an in-ear state. Further to this, the removable earbud attachment element is configured to, when used, engage the configuration circuit and the configuration circuit is configured to indicate that the speaker module is at the first state responsive to engagement by the earbud attachment element.

For example, the configuration circuit may be configured to determine the state of the speaker module by one or more of electro-mechanical detection, electro-acoustic detection or proximity sensing.

In one variant, the speaker module further comprises a housing arranged to at least partly encompass the speaker element. The housing is provided with one or more openings configured to provide an audio-path from the speaker element out through the housing. The removable earbud attachment element is configured to, when used, further engage the audio-path thereby providing an acoustically open resonance chamber between the speaker element and an eardrum of a user of the reconfigurable earbud earphone.

In one variant, the removable earbud attachment element is replaceable by a removable in-ear attachment element configured to, when used, engage the configuration circuit. The configuration circuit is further configured to indicate that the speaker module is at the second state responsive to engagement by the removable in-ear attachment element.

In one variant, the speaker module is the speaker module according to the first aspect.

In a third aspect, a reconfigurable in-ear earphone is presented. The reconfigurable in-ear earphone comprises a speaker module and a removable in-ear attachment element. The speaker module comprises a speaker element, an interface for receiving audio, a configurable driver circuit configured to drive the speaker element based on audio provided from the interface, and a configuration circuit operatively connected to the configurable driver circuit. The configurable driver circuit is configured to operate at a first configuration responsive to the configuration circuit indicating a first state of the speaker module and at a second configuration responsive to the configuration circuit indicating a second state of the speaker module, wherein the first state is an earbud state, and the second state is an in-ear state. The removable in-ear attachment element is configured to, when used, engage the configuration circuit and the configuration circuit is configured to indicate that the speaker module is at the second state responsive to engagement by the in-ear attachment element.

For example, the configuration circuit may be configured to determine the state of the speaker module by one or more of electro-mechanical detection, electro-acoustic detection or proximity sensing.

In one variant, the speaker module further comprises a housing arranged to at least partly encompass the speaker element. The housing is provided with one or more openings configured to provide an audio-path from the speaker element out through the opening of the housing. The removable in-ear attachment element is configured to, when used, further engage the audio-path thereby providing a substantially closed resonance chamber between the speaker element and an eardrum of a user of the reconfigurable in-ear earphone.

In one variant, the reconfigurable in-ear earphone further comprises a housing. The housing is formed as an earbud and arranged to at least partly encompass the speaker element. This is beneficial as no additional elements are required when operating the speaker module at the earbud state.

In one variant, the configuration circuit is further configured to, responsive to removal of the in-ear attachment element, indicate that the speaker module is at the first state.

In one variant, the removable in-ear attachment element is replaceable by a removable earbud attachment element configured to, when used, engage the configuration circuit. The configuration circuit is further configured to indicate that the speaker module is at the first state responsive to engagement by the removable earbud attachment element.

In one variant, the speaker module is the speaker module according to the first aspect.

In a fourth aspect, a modular speaker system is presented. The modular speaker system comprises a speaker module according to the first aspect and a removable in-ear attachment element. The removable in-ear attachment element is configured to, when used, engage the configuration circuit and the configuration circuit is configured to indicate that the speaker module is at the second state responsive to the engagement by the removable in-ear attachment element.

In one variant, the modular speaker system further comprises a removable earbud attachment element. The removable earbud attachment element is configured to, when used, engage the configuration circuit and the configuration circuit is configured to indicate that the speaker module is at the first state responsive to the engagement by the removable earbud attachment element.

In one variant, the modular speaker system is a stereo system comprising at least two speaker modules according to the first aspect, and at least two removable in-ear attachment elements.

In one variant, the modular speaker system is configured as a true wireless stereo system, TWS-system.

In a fifth aspect, a method for reconfiguration of a speaker module is presented. The speaker module comprises a speaker element, an interface for receiving audio, a configurable driver circuit configured to drive the speaker element based on audio provided from the interface, and a configuration circuit operatively connected to the configurable driver circuit. The method comprises determining, by means of a sensor circuit of the configuration circuit, a state of the speaker module (e.g., by one or more of electro-mechanical detection, electro-acoustic detection or proximity sensing) and configuring the speaker module at a first configuration responsive to the determined state being a first state. The method further comprises configuring the speaker module at a second configuration responsive to the determined state being a second state. The first state is an earbud state, and the second state is an in-ear state.

In one variant, the speaker module comprises a sensor circuit. The method further comprises fine-tuning the configurable driver circuit based on data obtained from the sensor circuit.

In a sixth aspect, a data processing circuit is presented. The data processing circuit is operatively connected to a speaker module according to the first aspect and configured to cause the execution of the method according to the fifth aspect.

In a seventh aspect, a computer program product comprising a non-transitory computer readable medium is presented. The non-transitory computer readable medium having thereon a computer program comprising program instructions. The computer program being loadable into a data processing circuit and configured to cause execution of the method according to the fifth aspect when the computer program is executed by the data processing circuit.

### BRIEF DESCRIPTION OF THE DRAWINGS

Embodiments of the invention will be described in the following; references being made to the appended diagrammatical drawings which illustrate non-limiting examples of how the inventive concept can be reduced into practice.

FIG. 1a is a view of an ear,

FIG. 1b is a cross-sectional view of an ear,

FIG. 1c is a simplified cross-sectional view of an ear with an earbud earphone according to some embodiments of the present disclosure,

FIG. 1d is a simplified cross-sectional view of an ear with an in-ear earphone according to some embodiments of the present disclosure,

FIG. 2a is a block diagram of a speaker module according to some embodiments of the present disclosure,

FIG. 2b is a simplified perspective view of a speaker module according to some embodiments of the present disclosure,

FIGS. 3a-c are perspective views of speaker modules and in-ear attachment elements according to some embodiments of the present disclosure,

FIGS. 4a-b are perspective views of speaker modules and earbud attachment elements according to some embodiments of the present disclosure,

FIG. 4c is a perspective view of a speaker module in the shape of an earbud earphone according to some embodiments of the present disclosure,

FIG. 5 is a block diagram of a configuration circuit according to some embodiments of the present disclosure,

FIG. 6a is a view of a reconfigurable earbud earphone according to some embodiments of the present disclosure,

FIG. 6b is a view of a reconfigurable in-ear earphone according to some embodiments of the present disclosure,

FIG. 7a is a view of a reconfigurable earbud earphone according to some embodiments of the present disclosure,

FIG. 7b is a view of a reconfigurable in-ear earphone according to some embodiments of the present disclosure,

FIG. 8 is a view of a true wireless speaker module according to some embodiments of the present disclosure,

FIGS. 9a-d are views of modular speaker systems according to some embodiments of the present disclosure,

FIG. 10 is a view of a modular speaker system according to some embodiments of the present disclosure,

FIG. 11 is a block diagram of a method for reconfiguration of a speaker module according to some embodiments of the present disclosure,

FIG. 12 is a block diagram of a data processing circuit according to some embodiments of the present disclosure,

FIG. 13 is a view of a computer program product according to some embodiments of the present disclosure, and

FIG. 14 is a block diagram of the laudability of the computer program product according to some embodiments of the present disclosure.

### DETAILED DESCRIPTION OF EMBODIMENTS

Hereinafter, certain embodiments will be described more fully with reference to the accompanying drawings. The invention described throughout this disclosure may, however, be embodied in many different forms and should not be construed as limited to the embodiments set forth herein; rather, these embodiments are provided by way of example so that this disclosure will be thorough and complete, and will fully convey the scope of the invention, such as it is defined in the appended claims, to those skilled in the art.

The term “coupled” is defined as connected, although not necessarily directly, and not necessarily mechanically. Two or more items that are “coupled” may be integral with each other. The terms “a” and “an” are defined as one or more unless this disclosure explicitly requires otherwise. The terms “substantially,” “approximately,” and “about” are defined as largely, but not necessarily wholly what is specified, as understood by a person of ordinary skill in the art. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method that “comprises,” “has,” “includes” or “contains” one or more steps possesses those one or more steps, but is not limited to possessing only those one or more steps.

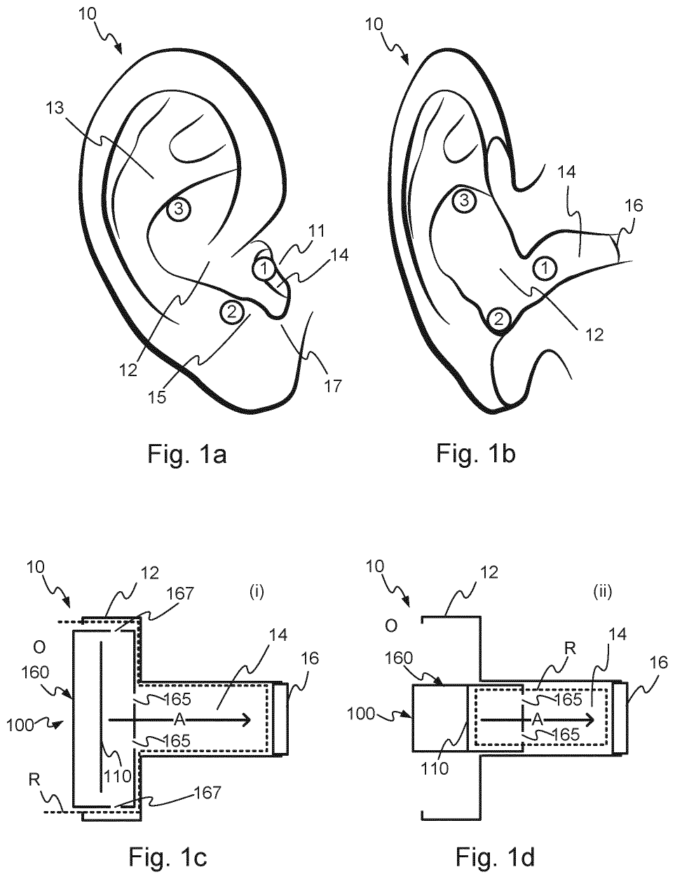

In the present disclosure, the terms in-ear and earbud will be used in reference to an audio listening device e.g. a headphone, an earphone etc. Throughout the present disclosure, earphones are defined as any kind of headphones that engage and are attached to a listener primarily at an inside of an outer ear 10, see FIGS. 1a-b, of the listener. This is different from e.g. on-ear headphones and/or over-ear headphones that generally stay in place by an arch member or similar connecting a left and a right speaker of the headphones and engaging a head (e.g. resting on top of the head, biasing the elements towards the ears etc.) of the user to ensure that the speakers stay in position. In order to have a consistency in terms, FIG. 1a shows a view of an ear 10 and FIG. 1b shows the same ear 10 in a cross-sectional view. The ear 10 comprises a tragus 11 partly occluding an ear canal 14 of the ear 10. The ear canal 14 opens up, at an end facing out of the ear 10, into a concha 12. The concha 12 is at an, in FIGS. 1a and b, vertically upper end defined by an antihelix 13 and at a vertically lower end, by an antitragus 15 and an intertragic notch 17. The intertragic notch 17 is located between the tragus 11 and the antitragus 15. An ear 10 as presented with reference to FIGS. 1a and 1b may be described as comprising three earphone fastening locations 1, 2, 3. A first earphone fastening location 1 is located in the ear canal 16. A second earphone fastening location 2 is located at, or underneath, the antitragus 15, i.e. between the antitragus 15 and the concha 12 or behind the antitragus 15 at a pocket at a bottom of the concha 12. A third earphone fastening location 3 is located at, or underneath, the antihelix 13, i.e. between the antihelix 13 and the concha 12.

The definition adhered to when referencing earbud earphones, earbuds for short, and in-ear earphones, in-ears for short, throughout the present disclosure will be further explained with reference to FIG. 1c and FIG. 1d. FIGS. 1c-d show a simplified cross-sectional view of the ear 10 comprising a schematic speaker module 100 according to the present disclosure. In FIG. 1c, the speaker module 100 is shown in an earbud configuration, i.e. the speaker module 100 is configured as an earbud. In FIG. 1d the same speaker module 100 is shown in an in-ear configuration, i.e. the speaker module 100 is configured as an in-ear.

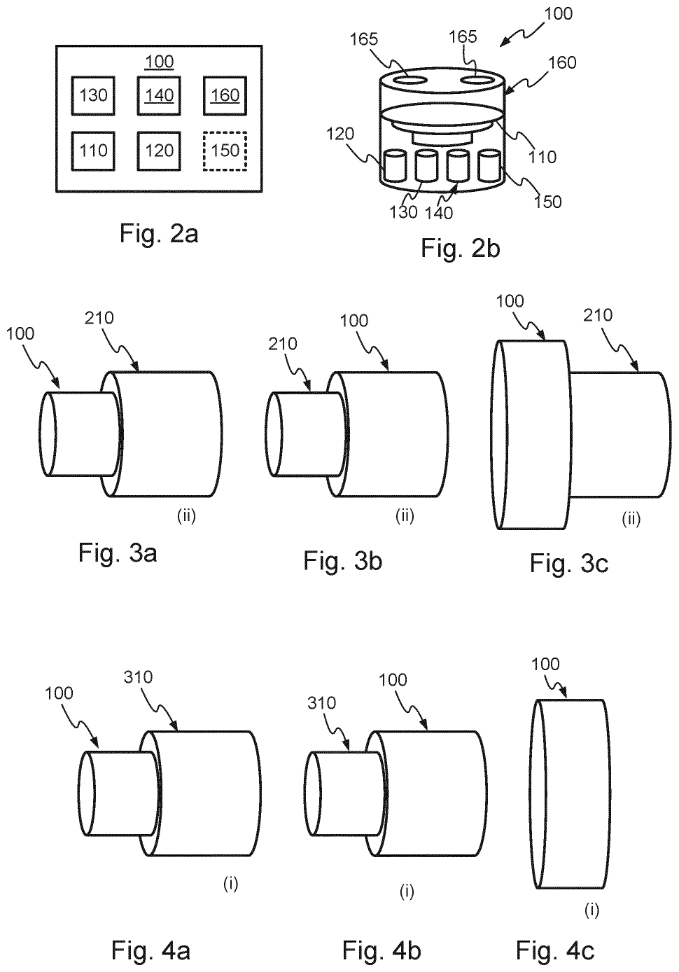

As shown in FIG. 1c, an earbud earphone is an earphone that generally does not extend into the ear canal 14. An earbud is generally attached to outer parts of the ear 10, e.g. at the second and third earphone fastening locations 2, 3. The earbud is characterized in that the earbud does not form a tight seal between the eardrum 16 and the earbud (or rather a speaker element of the earbud). This means that an open resonance chamber R (shown with a dotted outline in FIG. 1c) is formed between the eardrum 16 and a speaker element 110 (see FIGS. 2a and 2b) of the speaker module 100. That is to say, when an earbud is used (when the speaker module 100 is configured as an earbud), the ear canal 14 is in fluid communication with an outside O of the ear 10. In other words, the resonance chamber R is in acoustically fluid communication with the outside O of the ear 10.

Correspondingly, as shown in FIG. 1d, an in-ear earphone is an earphone that generally extend into the ear canal 14. An in-ear earphone is generally primarily attached to inner parts of the ear 10 at the first earphone fastening location 1. An in-ear is an earphone that forms a substantially air tight (a small vent is generally included to avoid discomfort from e.g. vacuum) seal around the ear canal 14. This means that a closed resonance chamber R (shown with a dotted outline in FIG. 1d) is formed between the eardrum 16 and the speaker element 110 of the speaker module 100. That is to say, the in-ear (or the speaker module 100 when configured as an in-ear) is generally arranged at least partly past the concha 12 and to extend into the ear canal 14. The in-ear commonly have a flexible tip configured to be arranged in the ear canal 14 in order to keep the in-ear attached at the ear 10. It should be mentioned that non-flexible tips are also to be considered for the present disclosure, e.g. tips made from acrylics, especially for custom molds.

There are benefits and drawback with either an in-ear earphone or an earbud headphone. For instance, in-ears generally provide a secure fit and a comparably good acoustic seal. Further to this, functionality such as Active Noise Cancellation, ANC is comparably easy to implement and apply with accurate performance. However, in-ears may be regarded as conveying a feeling of isolation as it may be difficult to hear surroundings in a natural way. This is due to the sealed resonance chamber R effectively providing isolation from sound at an outside O of the in-ear. Generally, in-ears may be provided with microphones 150 (see FIG. 2a) to provide hear-through functionality of surrounding sounds. Hear-through may cause colorations, resonances, directionality issues etc. Earbuds on the other hand, are generally considered comfortable to wear for long periods, they provide better passive hear-through compared to in-ears due to their open resonance chambers R. However, earbuds are generally more prone to sound leaking out from the ear 10, and noise leaking into the ear 10. Due to the open resonance chamber R and the generally dynamic fit of the earbud, ANC is more challenging and may in some cases be insufficient.

With reference to FIGS. 2a and 2b, the speaker module 100 will be further explained. FIG. 2a schematically shows the features of the speaker module 100, and FIG. 2b presents an illustrative perspective view of the speaker module 100. The speaker module 100 comprises a speaker element 110, an interface 120 for receiving audio and a configurable driver circuit 130. The configurable driver circuit 130 is configured to drive the speaker element 110 based on audio provided obtained by the interface 120. Preferably, the speaker module 100 comprises a housing 160. The housing 160 may be configured to, at least partially, encompass the speaker element 110. In some embodiments, depending on how much of the speaker element 110 the housing 160 encompasses, it may be beneficial to provide the housing 160 with one or more openings 165 for emission of audio. As is indicated in FIGS. 1c and 1d, the speaker module 100 may be configured to operate at a first state (i), an earbud state (i) as shown in FIG. 1c. The speaker module 100 may further be configured to operate at a second state (ii), an in-ear state (ii) as shown in FIG. 1d. To this end, the speaker element 110 may be any suitable speaker element 110 suitable for providing sufficient sound pressure when the speaker module is configured to operate at the earbud state (i). The earbud state (i) will generally require more power in order to achieve a desired Sound Pressure Level (SPL) due to the open resonance chamber R. This additional power may be provided by the configurable driver circuit 130 being capable increasing its gain and thereby the drive provided to the speaker element 110. Consequently, the configurable driver circuit 130 is generally configured to increase a sound pressure provided by the speaker element 110 when the speaker module 100 is configured to operate at the earbud state (i) compared to when the speaker module 100 is configured to operate at the in-ear state (ii). It should be mentioned that, in order to ensure linear sound reproduction with limited unwanted distortion, the speaker element 110 and the configurable driver circuit 130 are preferably both dimensioned to manage the higher SPL required at the earbud state (ii). Correspondingly, this may be described in the opposite way, i.e. that the configurable driver circuit 130 is generally configured to decrease a sound pressure provided by the speaker element 110 when the speaker module 100 is configured to operate at the in-ear state (ii) compared to when the speaker module 100 is configured to operate at the earbud state (i). In order to determine which state (i), (ii) the configurable driver circuit 130 should operate at, the speaker module 100 may further comprise a configuration circuit 140 configured to indicate, at least, whether the speaker module 100 is at the first state (i), the earbud state (i), or at the second state (ii), the in-ear state (ii). Responsive to the configuration circuit 140 indicating the first state (i), the configurable driver circuit 130 will be configured to operate at a first configuration, and responsive to the configuration circuit 140 indicating the second state (ii), the configurable driver circuit 130 will be configured to operate at a second configuration. The first configuration is an earbud configuration and the second configuration is an in-ear configuration.

As indicated above, the first configuration, the earbud configuration, will generally comprise a higher gain compared to the second configuration, the in-ear configuration. In order to decrease a risk of damaging hearing of a user, the speaker module 100 may be configured at the in-ear configuration (the lower gain configuration) as a default configuration. In some embodiments, the configurable driver circuit 130 is configured to apply the in-ear configuration unless the earbud state (ii) is indicated by the configuration circuit 140.

As seen in FIG. 1c, at the earbud state (i), an audio-path A is provided through the openings 165 of the housing 160, to the eardrum 16 of the user. This provides, as previously indicated, a resonance chamber R, indicated by the dotted line in FIG. 1c, that is acoustically open. That is to say, the ear canal 14 is not sealed by the speaker module 100 at the earbud state (i), but in fluid communication with the outside O of the ear 10. The resonance chamber R is preferably in fluid communication with the outside O in a path external to the speaker module 100 by e.g. gaps formed between the concha 12 and the housing 160. Alternatively, or additionally, gaps may be provided between sides of the speaker module 100 and the ear 10. That is to say, gaps may be formed between the housing 160 and e.g. the antihelix 13, the tragus 11, the intertragic notch 17 or the antitragus 15. In order to ensure a controlled leakage, i.e. open characteristic of the resonance chamber R, the housing 160 may be provided with one or more controlled leakage holes 167. The controlled leakage holes 167 are preferably arranged to face one or more of the intentional gaps between the speaker module 100 and the ear 10. Additionally, or alternatively, the resonance chamber R may be in fluid communication with the outside O of the ear 10 in a path through the speaker module 100 by e.g. gaps between the speaker element 110 and the housing 160 which is paired openings at a back (a side facing the outside O of the ear 10) of the speaker module 100. It should be mentioned that, if the speaker module 100 is provided with controlled leakage holes 167, it may be preferable, but not mandatory, to reduce the controlled leakage holes 167 in size or fluidly isolate them from the audio path A when the speaker module 100 is operating at the in-ear state (ii).

Correspondingly, as seen in FIG. 1d, at the in-ear state (ii), the corresponding audio-path A is provided, through the openings 165 of the housing 160, to the eardrum 16 of the user. Due to the tight fit of the speaker module 100 at the first earphone fastening location 1, the second configuration (ii) provides an acoustically closed resonance chamber R, indicated by the dotted line in FIG. 1d. That is to say, the ear canal 14 is substantially fluidly sealed from the outside O of the ear 10 by the speaker module 100 at the in-ear state (ii). As previously mentioned, in order to reduce discomfort due to e.g. vacuum, the seal is preferably not air-tight.

It should be mentioned that the controlled leakage holes 167 although only shown in the earbud of FIG. 1c, may be beneficial also for the in-ear of FIG. 1d. For an in-ear, the controlled leakage holes 167 are beneficial to provide a controlled leakage due to the occlusion effect inherent to the in-ear earbud.

Further to this, regardless of configuration, it may be beneficial to provide rear openings in the hosing 160 as rear vents (not shown). The rear vents are configured to permit a speaker membrane of the speaker element 110 to move freely (as sound waves are generated) without building up air pressure at a back of the speaker element 110. That is to say, when the speaker membrane is urged in a direction along the audio path A, air may be sucked into the housing 160 through the rear vents. Correspondingly, when the speaker membrane is urged in an opposite direction of the audio path A, air may be pushed out from the housing 160 through the rear vents.

In some embodiments, the configurable driver circuit 130 may provide different equalization settings depending on which state (i), (ii) the configuration circuit 140 indicates. The equalization settings may comprise e.g. a frequency dependent gain such that a gain curve may be different between the configurations. To exemplify, due to the open resonance chamber R of the earbud state (i), the configurable driver circuit 130 may be configured to apply a gain curve having a greater gain at lower frequencies in the first configuration compared to a gain curve applied at the second configuration. In other words, the configurable driver circuit 130 may be configured to provide more bass at the earbud state (i) compared to the in-ear state (ii). It should be said that the lower frequencies mentioned are for explanatory reasons, as the skilled person will appreciate, there may very well be differences also at other frequencies (e.g. mid and/or high frequency regions) due to changes in resonances provided by the resonance chamber R, i.e. changes in the acoustic environment. The configurations may additionally, or alternatively, be configured to provide different sound signatures, e.g. different coloring of the sound, depending on which state (i), (ii) the speaker module 100 is at.

It should be mentioned that there may be further differences between the first configuration and the second configuration in addition to the gain. These may comprise different configurations for e.g. ANC (if used). To this end, the speaker module 100 may further comprise one or more microphones 150, FIGS. 2a-b. It should be noted that although FIGS. 2a-b only show one microphone 150 each, any number of microphones 150 may be comprised in the speaker module 100. Further to this, the placement of the microphone 150 at an opposite end of the openings 165 of the housing 160 (i.e. behind the speaker element 110) in FIG. 2b, is one exemplary placement. In some embodiments it is beneficial to arrange one or more microphones 150 in front of the speaker element 110, or have microphones 150 both in front of, and behind, the speaker element 110. Some microphones 150 may be configured to obtain/detect/sense an ambient sound (e.g. audio, noise etc.) of the speaker module 100 and/or the ear canal 14. The speaker module 100 may be configured to provide ANC based on the ambient sound obtained by the microphone 150. The ambient sound is preferably obtained by the one or more microphones 150 arranged to, when used, sense audio at the outside O of the ear 10. In some embodiments, in order to improve the ANC, one or more microphones 150 may be configured as reference microphones 150 arranged to sense audio in, and/or at, the ear canal 14. By removing the audio provided from the interface 120 from the ambient sound obtained from the reference microphones, a residual noise of ear canal 14 may be estimated. Based on the residual noise, an efficiency of the ANC may be determined and controlled. The implementation of ANC in an earbud or in-ear earphone is known to the skilled person. However, the configuration of the ANC is quite different between that of an in-ear earphone and an earbud due to e.g. differences in sound leakage and size of resonance chambers. Consequently, the first configuration of the configurable driver circuit 130 may comprise ANC settings configured for an earbud and the second configuration of the configurable driver circuit 130 may comprise ANC settings configured for an in-ear. Further to this, the configurable driver circuit 130 may be configured to (continuously/repeatedly) control, e.g. fine-tune the ANC settings based on the residual noise of the ear canal 14.

In some embodiments, the speaker module 100 may be configured to be used with a removable in-ear attachment element 210, or in-ear attachment element 210 for short. This is shown in FIGS. 3a-c. The in-ear attachment element 210 is preferably configured to fit comfortably and tightly at the first earphone fastening location 1 in the ear canal 14. The in-ear attachment element 210 may be formed differently depending on a size of the speaker module 100 and the ear canal 14. In FIGS. 3a-c, the speaker module 100 is illustrated as having a substantially cylindrical shape, this is for explanatory reason, and the speaker module 100 may be of any suitable regular or irregular shape, size or form. In FIG. 3a, the speaker module 100 is a, compared to the ear canal 14, small speaker module 100 and the speaker module 100 is configured to be, at least partially, arranged inside the in-ear attachment element 210. Additionally, or alternatively, a protrusion or similar of the in-ear attachment element 210 may extend into the speaker module 100 and attach the in-ear attachment element 210 to the speaker module 100. In FIG. 3b, the speaker module 100 is larger than the ear canal 14 and the in-ear attachment element 210 is configured to be, at least partially, arranged inside the speaker module 100. Additionally, or alternatively, a protrusion or similar of the speaker module 100 may extend into the in-ear attachment element 210 and attach the speaker module 100 to the in-ear attachment element 210. In FIG. 3c, a version of the embodiment of FIG. 3b is shown, wherein the speaker module 100 is formed as an earbud. The in-ear attachment element 210 may be attached to the earbud-shaped speaker module 100 by e.g. engaging protrusions of the speaker module 100, and/or be provided with protrusions or other means configured for attaching the in-ear attachment element 210 to the earbud-shaped speaker module 100.

In some embodiments, the speaker module 100 may be configured to be used with a removable earbud attachment element 310, or earbud attachment element 310 for short. This is shown in FIGS. 4a and b. The earbud attachment element 310 is preferably configured to fit comfortably in the concha 12 of the ear 10, or to attach to an outer outline of the ear 10 at e.g. the second and/or third earphone fastening locations 2, 3. As will be explained elsewhere, in some embodiments, the earbud attachment element 310 may be configured to engage and attach to the first earphone fastening location 1. The earbud attachment element 310 may be formed differently depending on a size of the speaker module 100 and the concha 12. As in FIGS. 3a-c, in FIGS. 4a and b, the speaker module 100 is illustrated as having a substantially cylindrical shape, this is for explanatory reason, and the speaker module 100 may be of any suitable regular or irregular shape, size or form. In FIG. 4a, the speaker module 100 is a, compared to the concha 12, small speaker module 100 and the speaker module 100 is configured to be, at least partially, arranged inside the earbud attachment element 310. Additionally, or alternatively, a protrusion or similar of the earbud attachment element 310 may extend into the speaker module 100 and attach the earbud attachment element 310 to the speaker module 100. In FIG. 4b, the speaker module 100 is larger than the concha 12 and the earbud attachment element 310 is configured to be, at least partially, arranged inside the speaker module 100. Additionally, or alternatively, a protrusion or similar of the speaker module 100 may extend into the earbud attachment element 310 and attach the speaker module 100 to the earbud attachment element 310. Of these two embodiments, the embodiment of FIG. 4a is a preferred embodiment. As shown in FIG. 3c, the speaker module 100 may in some embodiments be formed as an earbud.

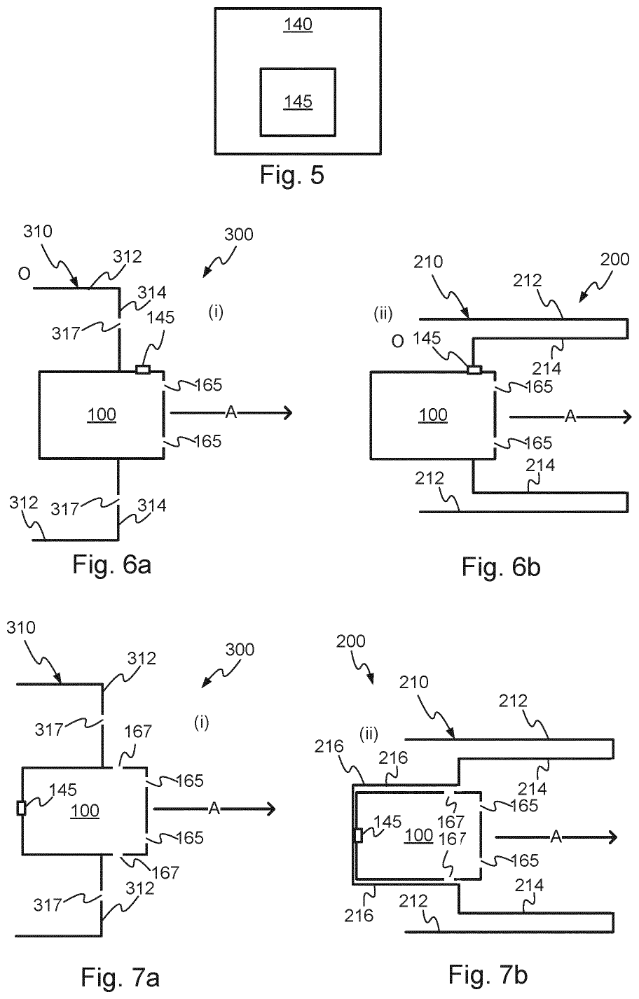

As explained, the configuration circuit 140 indicates, at least, if the speaker module 100 is at the first state (i) or at the second state (ii). In some embodiments, see FIG. 5, the configuration circuit 140 may comprise a sensor circuit 145. The sensor circuit 145 may be configured to sense, or otherwise detect, the state (i), (ii) of the speaker module 100. As will be explained herein, the sensor circuit 145 may be configured to obtain the state (i), (ii) of the speaker module 100 in numerous different ways. It should be mentioned that these different ways are not exclusive but may very well be combined. It should also be mentioned that the sensor circuit 145 is not necessarily comprised in the configuration circuit 140, the sensor circuit 145 may very well be comprised in the speaker module 100 itself and operatively or directly connected to the configurable driver circuit 130 and/or the configuration circuit 140.

In some embodiments, the sensor circuit 145 may comprise an electro-mechanical element. The electro-mechanical element may be a mechanical switch that is arranged such that it changes state (opens/closes) when the speaker module is transitioned between the first state (i) and the second state (ii). Such an arrangement may be exemplified by the switch being arranged such that it is engaged when the speaker module 100 is inserted into the ear canal 14. In this configuration, insertion into the ear canal 14 triggers the switch such that the second state (ii) may be accurately indicated by the configuration circuit 140. Alternatively, or additionally, the switch, or an additional switch, may be arranged such that it is triggered when the speaker module 100 is engaged by the in-ear attachment means 210. This may be accomplished by e.g. a protrusion of the speaker module 100 being engaged by an in-ear attachment element 210 and/or an earbud attachment element 310 and the protrusion activates (triggers) the switch. The opposite scenario may also be considered, the in-ear attachment means 210 and/or earbud attachment element 310 may be provided with a protrusion that triggers the switch. In such embodiments, the configuration circuit 140 will indicate that the speaker module 100 is at the second state (ii) responsive to the in-ear attachment element 210 being attached to, i.e. engaging, the speaker module 100 and/or that the speaker module 100 is at the first state (i) responsive to the earbud attachment element 310 being attached to, i.e. engaging, the speaker module 100. In some embodiments, one electro-mechanical element is arranged to be engaged by the in-ear attachment element 210 and one electro-mechanical element is arranged to be engaged by the earbud attachment element 310.

In some embodiments, the sensor circuit 145 may comprise an optical sensor. The optical sensor may be arranged to detect light entering the speaker module 100 through one or more state indicating openings. In some embodiments, the state indicating openings are different from the openings 165 and/or the controlled leakage holes 167 of the housing 160 of the speaker module 100. In some embodiments, more than one optical sensor is provided, wherein one is arranged to detect light from controlled leakage holes 167 and/or the openings 165 and one is arranged to detect light from one or more indicating opening. The state (i), (ii) of the speaker module 100 may be determined by comparing the light detected from the different openings. As the indicating openings are covered, obscured or otherwise engaged by e.g. the in-ear attachment element 210 or the earbud attachment element 310, the sensor circuit 145 may be configured to detect the corresponding state (i), (ii) and the configuration circuit may indicate the state (i), (ii) accordingly. In some embodiments, one optical sensor is arranged to be engaged by the in-ear attachment element 210 and/or one optical sensor is arranged to be engaged by the earbud attachment element 310.

In some embodiments, one or more optical sensors may be configured to detect proximity of an object by time of flight. This may be achieved by providing a light source and detecting a time of flight for light generated by the light source to travel from the light source to an object and back to the optical sensor. The object may be a section or part of an earbud and/or in-ear attachment element 210, 310.

In some embodiments, the sensor circuit 145 may comprise an electro-acoustic element such as a microphone or ultra-sonic transducer. If implemented as a microphone, the microphone may be a dedicated microphone or one or more microphones 150 configured to provide feedback for e.g. ANC. The electro-acoustic element may be configured to determine a leakage of sound from the resonance chamber R, e.g. by comparing sound provided by the speaker element 110 and/or the ultrasonic transducer to sound detected by the microphone 150 (or ultrasonic transducers if applicable), preferably sound at the ear-canal 14. The leakage of sound, or an indicator of the leakage of sound, may be provided to the configuration circuit 140. The configuration circuit 140 may be configured to compare the leakage to a state leakage threshold. Responsive to the leakage being below the state leakage threshold, the configuration circuit 140 may be configured to indicate that the speaker module 100 is at the second state (ii). Responsive to the leakage being above the state leakage threshold, the speaker module 100 may be configured to indicate that the speaker module 100 is at the first state (i). In some embodiments, the state leakage threshold is defined as a range in order to providing hysteresis in the indicating of the state (i), (ii) of the speaker module 100.

In some embodiments, the sensor unit 145 may comprise a proximity sensing element. The proximity sensing element may be a capacitive sensor, an optical sensor, an ultrasonic transducer etc. The proximity sensing element may be arranged to sense a distance to the eardrum 16, a distance to walls of the ear canal 14, a distance to the concha 12 etc. In some embodiments, the proximity sensing element is arranged to be engaged by the in-ear attachment element 210. In some embodiments, the proximity sensing element is arranged to be engaged by the earbud attachment element 310. In some embodiments, one proximity sensing element is arranged to be engaged by the in-ear attachment element 210 and one proximity sensing element is arranged to be engaged by the earbud attachment element 310.

In some embodiments, the configuration circuit 140 comprises a user-operable switch element. The user-operable switch element is preferably operable between at least two settings, a first setting corresponding to the first state (i), i.e. the earbud state (i), and a second setting corresponding to the second state (ii), i.e. the in-ear state (ii). The configuration circuit 140 is preferably configured to indicate the state (i), (ii) of the speaker module 100 in accordance with the setting of the user-operable switch element. The user-operable switch element may be a physical switch or button, preferably comprised in the speaker module, and configurable by a user of the speaker module 100. In some embodiments, the user-operable switch element is a software setting that may be controller by the user via e.g. a wireless interface such as Bluetooth. In some embodiments, the user-operable switch element may be controlled through an application running on a mobile phone wirelessly connected to the speaker module 100.

It should be mentioned that the embodiments presented of the configuration circuit 140 and the sensing circuit 145 are to exemplify implementations. It should be noted that these different embodiments may very well be combined, duplicated or otherwise refined in order to increase the speed and/or accuracy in the indication provided by the configuration circuit 140.

Preferably, the in-ear attachment element 210 is formed as a passive device, e.g. a silicone sleeve, that removably attaches to the speaker module 100. However, in some embodiments, the in-ear attachment element 210 may be provided with a suitable identification token such as an RFID chipset, ID resistor etc. allowing the sensing circuit 145 to not only sense that an in-ear attachment element 210 is attached, but also a type of in-ear attachment element 210. The sensing circuit 145 may optionally be configured to associate the in-ear attachment element 210 with a specific user and configure the configurable driver circuit 130 to control the speaker element 110 according to settings associated with the specific user. In some embodiments, the earbud attachment element 310 may be provided with a suitable identification token such as an RFID chipset, ID resistor etc. allowing the sensing circuit 145 to not only sense that an earbud attachment element 210 is attached, but also a type of earbud attachment element 210. The sensing circuit 145 may optionally be configured to associate the earbud attachment element 210 with a specific user and configure the configurable driver circuit 130 to control the speaker element 110 according to settings associated with the specific user. The corresponding may be implemented with an earbud attachment element 310 comprising an identification token.

It has been shown that the configurable driver circuit 130 may provide different ANC settings and/or frequency dependent gain depending on the state (i), (ii) of the speaker module 100. However, the configurable driver circuit 130 may further be configured to control, i.e. fine-tune, the frequency dependent gain depending on changes in the acoustic environment. These changes may occur due to a changed fit of the speaker module 100 at the ear 10 such that a shape/size/form of the resonance chamber R changes. The fine-tuning of the frequency dependent gain may be based on data, indications, measurements etc. obtained from any suitable embodiment of the sensing circuit 145. In a preferred embodiment, one or more microphones 150 are configured to estimate the sound at the ear canal 14. The configuration circuit 130 may be configured to, based on the estimated sound at the ear canal 14 to detect changes in sound leakage (due to e.g. changed fit of the speaker module 100) and control the frequency dependent gain accordingly. Additionally, or alternatively, one or more microphones 150 may be configured to estimate the ambient sound of the speaker module. The configuration circuit 130 may be configured to, based on the estimated ambient sound to detect changes in ambient noise (due to e.g. presence of loud vehicles or noisy people) and control the frequency dependent gain accordingly, e.g. increase an SPL of the audio played such that a signal to noise ratio at the ear canal 14 is substantially constant.

With reference to FIGS. 6a and b, one exemplary embodiment of the speaker module 100, and earphones 200, 300 will be presented. FIG. 6a shows a speaker module 100 at the first state (i), the earbud state (i). The speaker module 100 is provided with an earbud attachment element 310 arranged as a member about (not necessarily radially encompassing) the speaker module 100. The earbud attachment element 310 may be formed with an outer member 312, preferably shaped to fit the ear 10 of the user, and an inner member 314 arranged between the outer member 312 and the speaker module 100. The inner member 314 may be provided with an opening into which the speaker module 100 may be inserted. The outer member 312 is arranged radially about the speaker module 100 and is configured to engage e.g. the concha 12, the antihelix 13 the tragus 11, the intertragic notch 17 and/or the antitragus 15, to attach the earbud attachment element 310 to the ear 10. The inner member 314 is attached to the outer member 312 at one end, and configured to engage the speaker module 100 at the other end. The inner member 314 is configured to face towards the ear canal 14 and may be provided with one or more earbud attachment element openings 317. The earbud attachment element openings 317 are through-hole openings configured to provide an acoustically open resonance chamber R between the ear drum 16 and the outside O of the speaker module 100. The earbud attachment element openings 317 may be omitted if an open resonance chamber R is provided by other means, e.g. an air gap between the earbud attachment element 310 and the ear 10, and/or the controlled leakage holes 167. The speaker module 100 is, in this embodiment, provided with an electro mechanical sensor circuit 145 arranged at a side of the speaker module at an end of the speaker module 100 comprising the openings 165, i.e. towards the audio path A, but facing in a direction of the concha 12/ear canal 14. The speaker module 100 may be inserted into the earbud attachment element 310 in a direction opposite to the audio path A such the earbud attachment element 310 may be attached to the speaker module 100 without triggering the electro mechanical sensor circuit.

In FIG. 6b, the same speaker module 100 is shown but with an in-ear attachment element 210 arranged about the speaker module 100. That is to say, the speaker module 100 of FIG. 6b is at the second state (ii), the in-ear state (ii). The in-ear attachment element 210 comprises an inner member 214 configured to engage and be attached to the speaker module 100 at one end, and to, when used, extend towards the eardrum 16 at the other end. In other words, the inner member 214 is open at both ends in order to provide the audio path A from the openings 165 of the speaker module to the eardrum 16. The inner member 214 may be configured to directly engage, and form a seal along, an inner surface of the ear canal 14. However, in order to increase comfort and to allow for greater flexibility, the in-ear attachment element 210 is preferably provided with an outer member 212 arranged radially outside the inner member 214 and connected to the inner member 214, preferably at the end configured for facing the eardrum 16. In such embodiments, the outer member 214 is configured to directly engage, and form a seal along, an inner surface of the ear canal 14. The outer member 212 may be arranged such that an air-gap is formed between the inner member 214 and the outer member 212 allowing increased flexibility and comfort of the in-ear attachment element 210. The in-ear attachment element 210 is preferably attached to the speaker module 100 by inserting the speaker module 100 into the in-ear attachment element 210 in a direction along the audio path A. When inserted, the sensor circuit 145, in this embodiment in the form of an electro mechanical sensor circuit, is triggered when the in-ear attachment element 210 is attached to the speaker module 100.

Turning to FIG. 7a, the corresponding view as in FIG. 6a is shown but the speaker module 100 is shown in an embodiment comprising controlled leakage holes 167. The controlled leakage holes 167 provide an open acoustic path from the eardrum 16 to the outside O of the speaker module 100. In such an embodiment, the earbud attachment element openings 317 are optional, but may be provided for e.g. increasing the acoustically open effect.

However, if the speaker module 100 comprises controlled leakage holes 167, these are preferably covered when the speaker module 100 is configured to operate at the in-ear state (ii). This is shown in FIG. 7b, wherein the in-ear attachment element 210 is configured to cover the controlled leakage holes 167 of the speaker module 100. To this end, the in-ear attachment element 210 is provided with a cylindrical portion 216. The cylindrical portion 216 is closed at one end open at an opposite end which is attached to the inner sleeve 214. The speaker module 100 may be inserted into the open end of the cylindrical portion 216 when used as an in-ear earphone. The sensor circuit 145 may be preferably arranged at a back of the speaker module 100, i.e. at a same side of the speaker module 100 as the controlled leakage holes 167, but may be arranged correspondingly to FIGS. 6a-b. This way, then the speaker module 100 is correctly, e.g. sufficiently, interested into the open end of the cylindrical portion 216 of the in-ear attachment element 210, the in-ear attachment element 210 trigger the sensor circuit 145. In some embodiments, not shown, the cylindrical portion 216 may be provided with openings, being smaller in size than, and configured to arranged radially outside the controlled leakage holes 167. This is to reduce the occlusion effect inherent to the closed resonance chamber R.

The attachment elements 210, 310 exemplified in reference to FIGS. 6a-7b may be interpreted as circular, or substantially circular in their engagement with the speaker module 100, the ear 10, the concha 12, the antihelix, 13 the tragus 11, the intertragic notch 17, the antitragus 15 and/or the ear canal 16. However, this is for explanatory reasons only, any or all of these engagements may be in any suitable shape size or form.

The speaker module 100 (according to any embodiment or example disclosed herein) comprising the removable earbud attachment element 310 (according to any embodiment or example disclosed herein) may be referred to as a reconfigurable earbud earphone 300 as shown in e.g. FIG. 6a or FIG. 7a.

The speaker module 100 (according to any embodiment or example disclosed herein) comprising the removable in-ear attachment element 210 (according to any embodiment or example disclosed herein) may be referred to as a reconfigurable in-ear earphone 200 as shown in e.g. FIG. 6b or FIG. 7b.

In some embodiments, the attachment elements 210, 310 are customized attachment elements 210, 310 adapter for a specific user. This means that the attachments elements 210, 310 may be sized for a specific shape of the ear 10, the concha 12, the antihelix, 13 the tragus 11, the intertragic notch 17, the antitragus 15 and/or the ear canal 14 of the user.

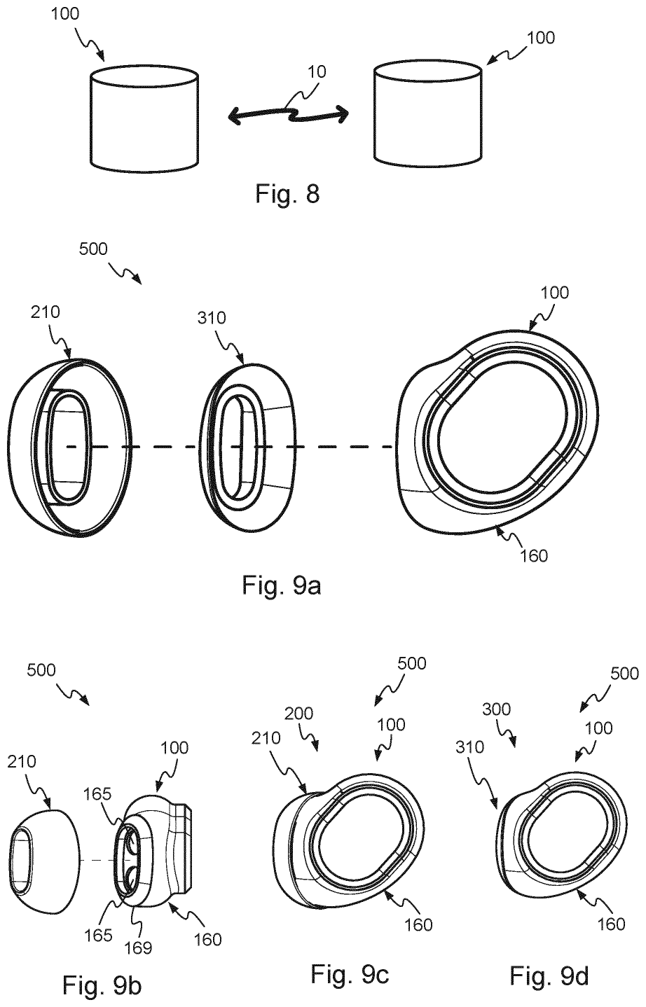

In FIG. 8, two speaker modules 100 according to the present disclosure are shown. The speaker modules 100 may be any of the speaker modules 100 presented herein but configured with a wireless interface 10 and configured to communicate with another (remote) speaker module 100 across the wireless interface. In this configuration, the speaker modules 100 may be referred to as true wireless stereo (TWS). The TWS 100 will wirelessly transfer required information, control data and synchronization in order to provide a true stereo (or more channels) experience to the user without requiring any cords between the speaker modules 100. It should be mentioned that the teachings of the present disclosure are also applicable to embodiments wherein two or more speaker modules are connected by a wired interface 10.

As previously indicated, the configurable driver circuit 130 is configured to drive the speaker element 110 based on audio provided from the interface 120 and an indication provided by the configuration circuit 140. However, in some embodiments, the configuration circuit 140, and/or the sensor circuit 145 may, as presented in reference to the frequency dependent gain, further be configured to provide detailed control data allowing the configurable driver circuit 130 to compensate for e.g. a changed fit of the speaker module 100. Further to this, in TWS and/or ANC enabled embodiments, the configuration circuit 140 may be configured to provide detailed control data relating to e.g. a difference in detected sound pressure between speaker modules 100 in TWS embodiments, changes or difference in leakage between the speaker modules 100 in ANC embodiments etc. Such changes may occur due to differences or changes in how the speaker modules 100 fit at the ear 10 of the user. The control may be visualized as a comparably slow outer control loop determining the state (i), (ii) of the speaker module 100 and a comparably fast inner control loop configured to fine-tune the performance of the configurable driver circuit 130 (e.g. fine-tune TWS configurations, gain, frequency dependent gain and/or ANC configurations) based on changes in the fit of the speaker module 100, the acoustic environment etc.

To exemplify, assume that the inner control loop of the speaker module 100 detects an increased leakage. The gain (and optionally frequency characteristics thereof) may be controlled to compensate for the increase in sound leakage. Assume further that the speaker module 100 forms part of a TWS and that the sound leakage mandates an increase in gain (and optionally frequency characteristics thereof) which saturates, or at least maximizes, a gain available from the configurable driver circuit 130 and/or the speaker element 110. In order to avoid that a balance in SPL between the speaker modules 100 forming the TWS system, is detuned, the configurable driver circuit 130 of the other speaker module 100 may be configured to reduce a gain (and optionally frequency characteristics thereof), to match the perceived SPL of the other speaker module 100. This provides a more balanced and comfortable listening experience.

With reference to FIGS. 9a to d, some exemplifying implementation examples of a modular speaker system 500 is shown. The modular speaker system 500 comprises a speaker module 100, an in-ear attachment element 210 and optionally, an earbud attachment element 310. In FIG. 9a, the modular speaker system 500 is shown comprising a speaker module 100 having a general earbud shape and being configured to be provided with an in-ear attachment element 210 or an earbud attachment element 310. As seen in FIG. 9a, both the in-ear attachment element 210 and the earbud attachment element 310 are shaped as tip-elements where the in-ear attachment element 210 is, as previously explained, configured to enter the ear-canal 14. The earbud attachment element 310 is, in this embodiment, optional but may be attached to the speaker module 100 in order to provide a more comfortable fit of the speaker module 100 in the ear 10 and a more controlled leakage of the open resonance chamber R provided at the earbud state (i). In FIG. 9b the same speaker module 100 and in-ear attachment element 210 as in FIG. 9a is shown, but rotated such that the openings 165 of the housing 160 of the speaker module 100 are visible. In FIG. 9b, a ridge 169 of the housing 160 is visible. The attachment elements 210, 310 of FIG. 9a-b may be configured to be arranged around an outer circumference of the ridge 169 when attached to the speaker module 100. Both the attachment elements 210, 310 may be configured in this way, but in some embodiment, one, or both, of the attachment elements 210, 310 are configured to be arranged at an inside of the ridge 169, such that a protrusion of the attachment elements 210, 310 engages an inside circumference of the ridge 169. In a preferred embodiment, the in-ear attachment means 210 is configured to engage the outside circumference of the ridge 169, and the earbud attachment element 310 is configured to engage the inside circumference of the ridge 169.

In FIG. 9c the speaker module 100 and the in-ear attachment element 210 of FIG. 9a are shown connected to form an in-ear earphone 200. This configuration may, as previously indicated, be referred to as the reconfigurable in-ear earphone 200. The in-ear attachment element 210 will form a tight seal with the ear canal 14 and attach the in-ear earphone 200 at the first earphone fastening locations 1. As the housing 160 of the speaker module 100, in this embodiment, is formed as an earbud, the in-ear earphone 200 may further be attached at the second earphone fastening location 2, and/or optionally, depending on the design of the housing 160 of the speaker module 100, at the third earphone fastening location 3.

Correspondingly, FIG. 9d shows the speaker module 100 and the earbud attachment element 310 of FIG. 9a connected to form an earbud earphone 300. This configuration may, as previously indicated, be referred to as the reconfigurable earbud earphone 300. The earbud attachment element 310 may be configured to extend partially into the ear canal 14 but will not form a tight seal between the ear drum 16 and the speaker element 110. As a consequence, the earbud earphone 300 will be attached at the first earphone fastening locations 1. Preferably, the earbud earphone 300 will not be attached to the ear solely at the ear canal 14, i.e. the first earphone fastening location 1, but may form a compared to an in-ear, soft locking point that partially help fixate or hold the earbud with assistance from other fastening locations 2, 3. Preferably, the earbud earphone 300 will be most dependent on fastening at the second fastening location 2, more preferable with the additional third fastening location 3, i.e. at the antihelix, or at the intertragic notch 17 to create a more secure fit. As the housing 160 of the speaker module 100, in this embodiment, is formed as an earbud, the earbud earphone 300 may further be attached at the second earphone fastening location 2, and/or optionally, depending on the design of the housing 160 of the speaker module 100, at the third earphone fastening location 3.

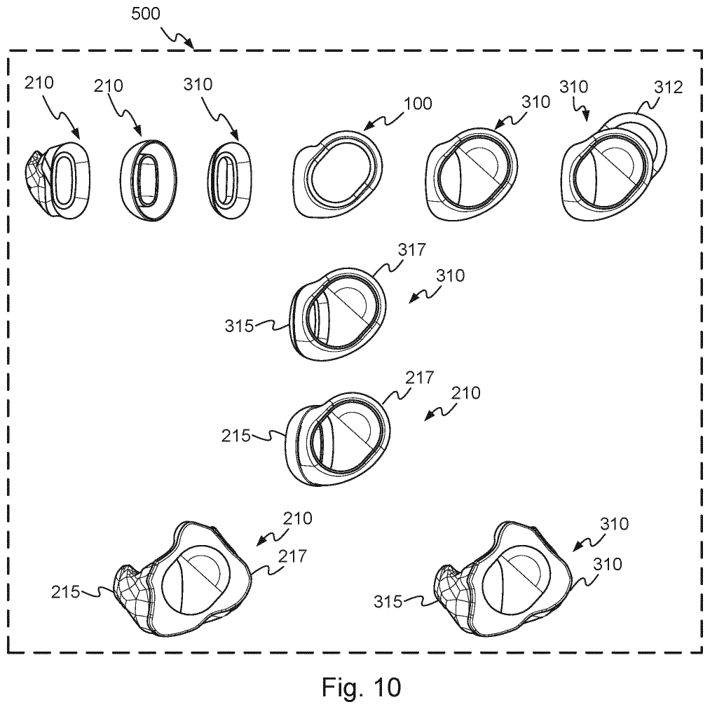

In FIG. 10, an overview of a plurality of different attachment elements 210, 310 are shown together with the speaker module 100 according to the present disclosure. This overview may be referred to as one embodiment of the modular speaker system 500, although further embodiments of the modular speaker system 500 may very well be formed with the speaker module 100 and any subset of the attachment elements 210, 310 of FIG. 10. In FIG. 10, horizontally aligned with the speaker module 100, two types of attachment elements 210, 310 are shown. To the left of the speaker module, tip-type attachment elements 210, 310 are shown, and to the right, sleeve-type attachment elements 310 are shown.

The tip-type attachment elements 210, 310 are characterized in that they generally engage the ear canal 14 and are adapted to attach at the first earphone fastening location 1. The leftmost tip-type attachment element 210 is a tip-type in-ear attachment element 210 configured with a custom tip. The custom tip may be molded, configured to or otherwise adapted to comfortably fit in the ear canal 14 of a specific ear 10. The second tip-type attachment element 210 from the left is a tip-type in-ear attachment element 210 with a generic tip, see e.g. FIG. 9c and associated description. The tip-type in-ear attachment elements 210 are configured to, when used, form a closed resonance chamber R between the ear drum 16 and the speaker element 110. The tip-type attachment element 310 closest to the left of the speaker module 100 is a tip-type earbud attachment element 310, see e.g. FIG. 9d and associated description. The tip-type earbud attachment element 310 is configured to, when used, partly extend into the ear canal 14 and form an open resonance chamber R between the ear drum 16 and the speaker element 110.

The sleeve-type attachment elements 310 are characterized in that they generally engage the ear 10 outside of the canal 14 and are adapted to attach at the second earphone fastening location 2 and/or the third earphone fastening location 3. The two sleeve-type attachment element 310 to the right of the speaker module 100 are both sleeve-type earbud attachment elements 310. Sleeve-type attachment elements 310 are characterized by forming a sleeve about the speaker module 100. Some sleeve-type attachment elements 310 may be custom sleeve-type attachment elements 310 (not shown) configured to, or otherwise adapted to comfortably fit in a specific ear 10 at the second earphone fastening location 2 and/or the third earphone fastening location 3. The rightmost sleeve-type earbud attachment elements 310 comprises a wing member 312. The wing member 312 is configured to engage the third earphone fastening location 3 and attach the sleeve-type earbud attachment elements 310 securely at the third earphone fastening location 3. The wing member 312 may be a flexible or rigid wing member 312.

In FIG. 10, directly below the speaker module 100 an earbud attachment element 310 is shown. The earbud attachment element 310 comprises a sleeve member 317 and a tip member 315. The sleeve member 317 may be the sleeve-type earbud attachment element 310 shown closest to the right of the speaker module 100 in FIG. 10, and the tip member 315 may be the tip-type earbud attachment element 310 in FIG. 9d. Combined, they form an earbud attachment element 310 as the tip member provides an open resonance chamber R. The tip member 315 and the sleeve member 317 may be fixedly attach to each other, formed as one piece or separate members attached individually to the speaker module 100. In FIG. 10, below this, a corresponding in-ear attachment element 210 is shown. The in-ear attachment element 210 comprises a sleeve member 217 and a tip member 215. The sleeve member 217 may be the sleeve-type earbud attachment element 310 shown closest to the right of the speaker module 100 in FIG. 10, and the tip member 215 may be the tip-type in-ear attachment element 210 in FIG. 9c. Combined, they form an in-ear attachment element 210 as the tip member provides a closed resonance chamber R. The tip member 215 and the sleeve member 217 may be fixedly attach to each other, formed as one piece or separate members attached individually to the speaker module 100.

For the sake of completeness, at the bottom of FIG. 10, an earbud attachment element 310 comprising a tip member 315 that may be a custom tip member 315 providing an open resonance chamber R. A corresponding in-ear attachment element 210 is shown comprising a tip member 215 that may be a custom tip member 215 shown at the upper left of FIG. 10.

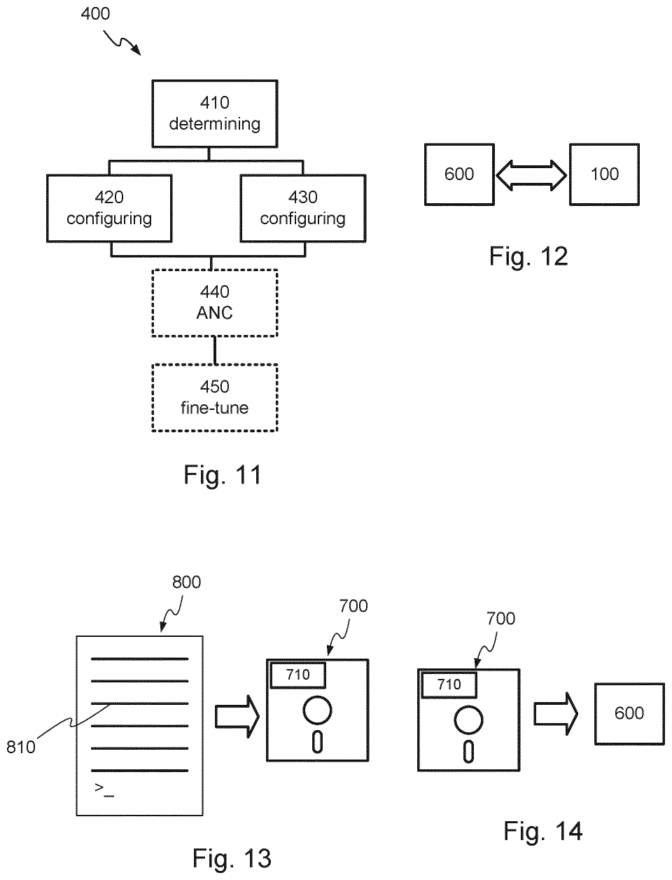

In FIG. 11, a method 400 for reconfiguring a speaker module 100 is shown. The speaker module 100 may be any speaker module 100 as presented herein, e.g. with reference to FIG. 2 with or without optional features as presented with reference to e.g. FIG. 5. The method 400 comprises determining 410 a state (i), (ii) of the speaker module 100. The state (i), (ii) may be determined in accordance with any suitable example, embodiment or feature presented herein. Preferably, the state (i), (ii) is determined by means of the sensor circuit 145 as detailed herein. The method 400 further comprises, if it is determined that the speaker module 100 is at the first state (i), configuring 420 the speaker module 100 to the first configuration, i.e. the earbud configuration. The method 400 further comprises, if it is determined that the speaker module 100 is at the second state (ii), configuring 430 the speaker module 100 to the second configuration, i.e. the in-ear configuration. The method 400 may further comprise performing ANC with a configuration based on the detected state (i), (ii). In some embodiments, the method comprises 400 comprises fine-tuning 450 the performance of the configurable driver circuit 130. The fine-tuning and/or the ANC may be performed according to any embodiment detailed herein. The method 400 may further comprise performing controlling TWS functionality of the speaker module 100 based on the detected state (i), (ii). In some embodiments, the method comprises 400 comprises fine-tuning 450 the TWS performance of the configurable driver circuit 130 in according to any embodiment detailed herein.

In FIG. 12, a data processing circuit 600 is shown. The data processing circuit 600 is operatively connected to the speaker module 100 as presented herein. In some embodiments, the data processing circuit 600 is comprised in the speaker module 100. The data processing circuit 600 is configured to cause the execution of the method as presented with reference to FIG. 11.

In FIG. 13, a computer program 800 is shown. The computer program 800 comprises program instructions 810. These program instructions 810, when executed, are configured to cause the execution of the method 400 as described with reference to FIG. 11. The computer program 800 may be stored onto a non-transitory computer readable medium 710 forming part of a computer program product 700 (illustrated as a vintage floppy drive in FIG. 13). As seen in FIG. 14, the computer program 800 is loadable into the data processing circuit 600 such that, when executed by the data processing circuit 600, the data processing circuit 600 cause the execution of the method 400 as described with reference to FIG. 11.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. For example, while embodiments of the invention have been described with reference in-ear and earbud earphones, persons skilled in the art will appreciate that the embodiments of the invention can equivalently be applied to any other configuration of earphones. Furthermore, although specific terms may be employed herein, they are used in a generic and descriptive sense only and not for purposes of limitation. Therefore, a person skilled in the art would recognize numerous variations to the described embodiments that would still fall within the scope of the appended claims. Furthermore, although individual features may be included in different claims (or embodiments), these may possibly advantageously be combined, and the inclusion of different claims (or embodiments) does not imply that a combination of features is not feasible and/or advantageous. In addition, singular references do not exclude a plurality. Finally, reference signs in the claims are provided merely as a clarifying example and should not be construed as limiting the scope of the claims in any way.

1. A speaker module, comprising:
a speaker element; and
an interface for receiving audio;
a configurable driver circuit configured to drive the speaker element based on audio provided from the interface; and
a configuration circuit operatively connected to the configurable driver circuit, wherein the configurable driver circuit is configured to operate at a first configuration responsive to the configuration circuit-indicating a first state of the speaker module and at a second configuration responsive to the configuration circuit detecting indicating a second state of the speaker module, wherein the first state is an earbud state, and the second state is an in-ear state.

2.-29. (canceled)

30. The speaker module according to claim 1, wherein the configuration circuit comprises a sensor circuit configured to detect a state of the speaker module.

31. The speaker module according to claim 30, wherein the sensor circuit comprises an electro-mechanical element configured to detect the state of the speaker module.

32. The speaker module according to claim 30, wherein the sensor circuit comprises an electro-acoustic element configured to detect the state of the speaker module.

33. The speaker module according to claim 30, wherein the sensor circuit comprises a proximity sensing element configured to detect the state of the speaker module.

34. The speaker module according to claim 1, wherein the configuration circuit comprises a user-operable switch element operable in at least one of a first setting and a second setting, wherein the configuration circuit is configured to indicate the first state responsive to the user-operable switch element being set to the first setting and to indicate the second state responsive to the user-operable switch element being set to the second setting.

35. The speaker module according to claim 1, wherein the interface is configured for communication across a wireless interface and further configured to communicate with a remote speaker module across the wireless interface.

36. The speaker module according to claim 1, further comprising one or more microphones, wherein the speaker module is configured to provide active noise cancellation by the configurable driver circuit and further being configured to drive the speaker element based on audio obtained from the one or more microphones.

37. The speaker module according to claim 1, further comprising a housing arranged to at least partly encompass the speaker element and wherein the housing of the speaker module is formed as an earbud.

38. A reconfigurable earbud earphone comprising:
a speaker module comprising a speaker element an interface for receiving audio, a configurable driver circuit configured to drive the speaker element based on audio provided from the interface, and a configuration circuit operatively connected to the configurable driver circuit; and
a removable earbud attachment element, and
wherein the configurable driver circuit is configured to operate at a first configuration responsive to the configuration circuit indicating a first state of the speaker module and at a second configuration responsive to the configuration circuit indicating a second state of the speaker module, wherein the first state is an earbud state, and the second state is an in-ear state,
wherein the removable earbud attachment element is configured to, when used, engage the configuration circuit and the configuration circuit is configured to indicate that the speaker module is at the first state responsive to engagement by the removable earbud attachment element.

39. The reconfigurable earbud earphone of claim 38, wherein the speaker module further comprises a housing arranged to at least partly encompass the speaker element wherein:
the housing is provided with one or more openings configured to provide an audio-path from the speaker element out through the housing, and
the removable earbud attachment element is configured to, when used, further engage the audio-path thereby providing an acoustically open resonance chamber between the speaker element and an eardrum of a user of the reconfigurable earbud earphone.

40. The reconfigurable earbud earphone of claim 38, wherein the removable earbud attachment element is replaceable by a removable in-ear attachment element configured to, when used, engage the configuration circuit and the configuration circuit is further configured to indicate that the speaker module is at the second state responsive to engagement by the removable in-ear attachment element.

41. A reconfigurable in-ear earphone comprising:
a speaker module, the speaker module comprising a speaker element an interface for receiving audio, a configurable driver circuit configured to drive the speaker element based on audio provided from the interface, and a configuration circuit operatively connected to the configurable driver circuit; and
a removable in-ear attachment element,
wherein the configurable driver circuit is configured to operate at a first configuration responsive to the configuration circuit indicating a first state of the speaker module and at a second configuration responsive to the configuration circuit indicating a second state of the speaker module, wherein the first state is an earbud state, and the second state is an in-ear state, and
wherein the removable in-ear attachment element is configured to, when used, engage the configuration circuit and the configuration circuit is configured to indicate that the speaker module is at the second state responsive to engagement by the removable in-ear attachment element.

42. The reconfigurable in-ear earphone of claim 41, wherein the speaker module further comprises a housing arranged to at least partly encompass the speaker element,
wherein the housing is provided with one or more openings configured to provide an audio-path from the speaker element out through the one or more openings of the housing, and
wherein the removable in-ear attachment element is configured to, when used, further engage the audio-path thereby providing a substantially closed resonance chamber between the speaker element and an eardrum of a user of the reconfigurable in-ear earphone.

43. The reconfigurable in-ear earphone of claim 41, further comprising a housing, wherein the housing is formed as an earbud and arranged to at least partly encompass the speaker element.

44. The reconfigurable in-ear earphone of claim 43, wherein the configuration circuit is further configured to, responsive to removal of the removable in-ear attachment element indicate that the speaker module is at the first state.

45. The reconfigurable in-ear earphone of claim 41, wherein the removable in-ear attachment element is replaceable by a removable earbud attachment element configured to, when used, engage the configuration circuit and the configuration circuit is further configured to indicate that the speaker module is at the first state responsive to engagement by the removable earbud attachment element.

46. A modular speaker system comprising the speaker module of claim 1 and a removable in-ear attachment element wherein the removable in-ear attachment element is configured to, when used, engage the configuration circuit and the configuration circuit is configured to indicate that the speaker module is at the second state responsive to the engagement by the removable in-ear attachment element.

47. The modular speaker system of claim 46, further comprising a removable earbud attachment element wherein the removable earbud attachment element is configured to, when used, engage the configuration circuit and the configuration circuit is configured to indicate that the speaker module is at the first state responsive to the engagement by the removable earbud attachment element.

48. The modular speaker system of claim 46, wherein the modular speaker system is configured as a true wireless stereo system.

49. A method for reconfiguration of a speaker module, the speaker module comprising a speaker element an interface for receiving audio, a configurable driver circuit configured to drive the speaker element based on audio provided from the interface, and a configuration circuit operatively connected to the configurable driver circuit, the method comprising:
determining, by means of a sensor circuit of the configuration circuit, a state of the speaker module;
configuring the speaker module at a first configuration responsive to the determined state being a first state; and
configuring the speaker module at a second configuration responsive to the determined state being a second state, wherein the first state is an earbud state, and the second state is an in-ear state.

50. The method of claim 49, wherein the speaker module comprises a sensor circuit, the method further comprising:
fine-tuning the configurable driver circuit based on data obtained from the sensor circuit.

51. A computer program product comprising a non-transitory computer readable medium, having thereon a computer program comprising program instructions, the computer program being loadable into a data processing circuit and configured to cause execution of the method according to claim 49 when the computer program is executed by the data processing circuit.
